(19) United States
(12) Patent Application Publication
(10) Pub. No.: US 2012/0237748 A1
(43) Pub. Date: Sep. 20, 2012

(54) POROUS CARBON MATERIAL AND MANUFACTURING METHOD THEROF

(76) Inventors: Hong-Ping LIN, Taipei City (TW); Yu-Ming Lin, Tainan City (TW); Hsieh-Ho Tsai, Kaohsiung City (TW); Likey Chen, Taipei City (TW)

(21) Appl. No.: 13/206,944

(22) Filed: Aug. 10, 2011

(30) Foreign Application Priority Data
Mar. 16, 2011 (TW) 100108871

(51) Int. Cl. C01B 31/02; B32B 3/26

(52) U.S. Cl. 428/219; 423/461

(57) ABSTRACT

An embodiment of the disclosure provides a manufacturing method of a porous carbon material, which includes: dissolving a surfactant and a carbon source material in a solvent to form an organic template precursor solution; preparing a silicate aqueous solution; pouring the organic template precursor solution into the silicate aqueous solution to precipitate out an intermediate, wherein the intermediate includes the surfactant, the carbon source material and a silicon oxide template; heating the intermediate to carbonize the intermediate; and removing the silicon oxide template to form a porous carbon material. Another embodiment of the disclosure provides a porous carbon material.

### CROSS REFERENCE TO RELATED APPLICATIONS

This Application claims priority of Taiwan Patent Application No. 100108871, filed on Mar. 16, 2011, and Taiwan Patent Application No. 100120108, filed on Jun. 9, 2011, the entirety of which is incorporated by reference herein.

### BACKGROUND

1. Field

The present disclosure relates to a porous material, and in particular relates to a porous carbon material and manufacturing methods thereof.

2. Description of the Related Art

Super capacitors are revolutionary for development of energy storage, and may replace traditional storage-batteries in certain fields in the future. The super capacitor is a new power energy storage device existing due to the advancement of material science, and the super capacitor is a new electrochemical device, which stores electrical energy by polarizing electrolytes. The global need of the super capacitor has risen quickly after commercial market availability, and has become a new superstar in the field of electrochemical power. The super capacitor has huge application value and market potential in the electric vehicle, mixed fuel vehicle, exceptional load vehicle, electrical power, railroad, communication, national defense, and consumer electronic product fields, etc.

The super capacitor has advantages of high charge-discharge speed, being pollution-free, having a long cycle life, etc, so the super capacitor is regarded as a new-type of green energy storage system for the present century. In view of the usage qualities of electrical power, the super capacitor has many advantages which are better than batteries, such as higher output power (>10 kW/kg), higher charge-discharge efficiency, and longer cycle life (>200,000 times). In view of energy saving, the super capacitor is an indispensable auxiliary energy source. Also, the characteristic of high discharge speed of the super capacitor can be used in uninterruptible power supplies, and the super capacitor can provide electric energy immediately at a power failure moment to recover essential response time of batteries.

In general, an electrode of the super capacitor is mainly of porous structure, which may be a micro-nanometer structure with a large surface area used to produce an electric double layer of an electrostatic charge storage device. Specifically, the super capacitor stores electrical energy by directly forming electrostatic charges on the electrode plate of the capacitor, and this kind of charge storage is called non-Faradic which means that there is no electron transfer occurring on the interface of the electrode.

The present commercial super capacitor is limited by the small specific surface area (500-1000 m2/g) of the carbon electrode material thereof, such that the energy density thereof is lower (<5 Wh/kg), and the electrical capacity thereof is around 5-35 F/g. The carbon electrode material with a large surface area and well pore properties can effectively improve the total efficiency of the super capacitor, but the present manufacturing method of this kind of the carbon electrode material (referring TW patent NO. I274453) takes a long process time (about 3-7 days) and high energy (a process temperature is 2000° C.).

### BRIEF SUMMARY

An embodiment of the disclosure provides a manufacturing method of a porous carbon material, which includes: dissolving a surfactant and a carbon source material in a solvent to form an organic template precursor solution; preparing a silicate aqueous solution; pouring the organic template precursor solution into the silicate aqueous solution to precipitate out an intermediate, wherein the intermediate includes the surfactant, the carbon source material and a silicon oxide template; heating the intermediate to carbonize the intermediate; and removing the silicon oxide template to form a porous carbon material.

An embodiment of the disclosure provides a porous carbon material, which includes: a porous carbon structure having a plurality of macropores, a plurality of mesopores and a plurality of micropores, wherein each of the macropores has a diameter larger than 50 nanometers, each of the mesopores has a diameter ranging from 2 nanometers to 50 nanometers, and each of the micropores has a diameter less than 2 nanometers, and a specific surface area of the porous carbon structure ranges from about 700 square meters per gram to 3000 square meters per gram, wherein a distribution proportion of the specific surface area of the macropores ranges from 10-35%, a distribution proportion of the specific surface area of the mesopores ranges from 25-40%, and a distribution proportion of the specific surface area of the micropores ranges from 30-60%, based on the total specific surface area of the porous carbon structure.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 depicts a manufacturing flow chart of a porous carbon material according to an embodiment of the present disclosure;

FIG. 2 is a transmission electron microscope (TEM) image of the porous carbon material of the Example 1;

FIG. 3 is a TEM image of the porous carbon material of the Example 2;

FIG. 4 is a TEM image of the porous carbon material of the Example 3;

FIG. 5 is a TEM image of the porous carbon material of the Example 4;

FIG. 6 is a TEM image of the porous carbon material of the Example 5;

FIG. 7 is a TEM image of the porous carbon material of the Example 6; and

FIG. 8 is a curve diagram showing that nitrogen adsorption/desorption curves of the porous carbon materials of the Example 3, the Example 4, and the Example 5.

### DETAILED DESCRIPTION

It is understood, that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numbers and/or letters in the various examples. This repetition is for the purpose of simplicity and clarity and does not in itself dictate a relationship between the various embodiments and/or configurations discussed. Furthermore, descriptions of a first layer “on,” “overlying,” (and like descriptions) a second layer, include embodiments where the first and second layers are in direct contact and those where one or more layers are interposing the first and second layers.

In the present disclosure, an organic-inorganic composite having a surfactant, a carbon source material, and a silicon oxide is formed by mixing an organic template precursor solution and a silicate aqueous solution together, and then the organic-inorganic composite is carbonized and the silicon oxide is removed from the organic-inorganic composite to form a porous carbon material with a plurality of macropores, a plurality of mesopores and a plurality of micropores.

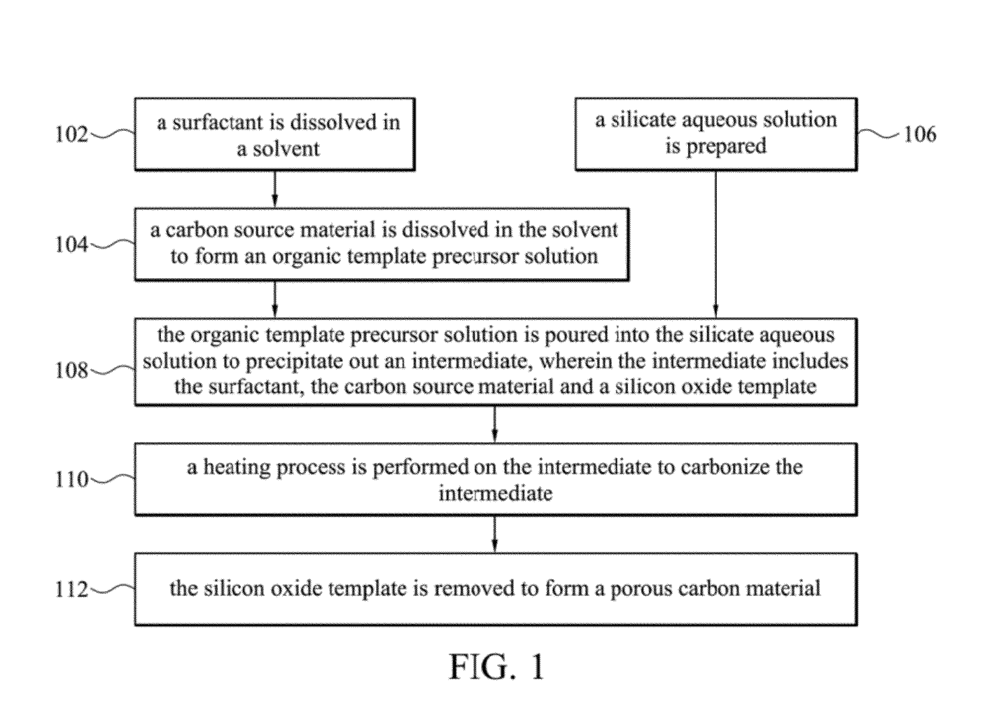

FIG. 1 depicts a manufacturing flow chart of a porous carbon material according to an embodiment of the present disclosure. Referring to FIG. 1, in step 102, a surfactant is dissolved in a solvent. Specifically, the solvent is, for example, water, alcohols, combinations thereof, or other suitable solvent materials, wherein the alcohol is, for example, ethanol. In one embodiment, the solvent includes water and ethanol, wherein a volume ratio of water to ethanol is 1:2. In other embodiments, a volume ratio of water to ethanol is 1:1, 5:1, or 10:1. The surfactant is, for example, gelatin, EO-PO triblock copolymer (e.g., EO₁₀₆PO₇₀EO₁₀₆, Pluronic F127), polyethylene glycol (PEG10000), combinations thereof, or other suitable surfactant materials.

Specifically, in step 102, the surfactant is disposed in the solvent, and the solvent is stirred for couple minutes to help the surfactant to be dissolved in the solvent. At this point, the solvent dissolved with the surfactant is a clarified liquid.

In step 104, a carbon source material is dissolved in the solvent to form an organic template precursor solution. Specifically, the carbon source material is, for example, phenolic resins, crosslinked and non-crosslinked polyacrylonitrile copolymers, sulfonated crosslinked polystyrene copolymers, modified crosslinked polystyrene copolymers, crosslinked sucrose, poly(furfuryl alcohol), polyvinyl chloride, combinations thereof, or other suitable carbon source materials, wherein the phenolic resin is, for example, phenol-formaldehyde condensation copolymer or resorcinol-formaldehyde condensation copolymer.

Specifically, in step 104, the carbon source material is added in the solvent dissolved with the surfactant. For example, 0.5-10 parts by weight of the carbon source material is added in the solvent dissolved with 1-5 parts by weight of the surfactant. At this point, the solvent may be disposed in a constant temperature bath, such that the carbon source material and the solvent achieve balance at a pre-determined temperature (e.g. 30° C., 40° C., 50° C., etc), and then the solvent is stirred for hours (e.g. 4 hours) at the pre-determined temperature to form the organic template precursor solution with polymeric micelles.

In step 106, a silicate aqueous solution is prepared. Specifically, in step 106, a silicate (e.g. sodium silicate) is disposed in water, and stirred for dissolution of the silicate to form the silicate aqueous solution. For example, 16 parts by weight of the silicate is dissolved in the water, and then a pH value of the silicate aqueous solution is adjusted to a pre-determined pH value, and the silicate aqueous solution is disposed in a constant temperature bath to achieve a pre-determined temperature (e.g. 1° C.-99° C., or 30° C.) and is maintained for an aging time (e.g. 7-8 minutes). In an embodiment, the pre-determined pH value of the silicate aqueous solution ranges from 2 to 7, such as about 4. In another embodiment, the pre-determined pH value of the silicate aqueous solution is less then about 2. In still another embodiment, the pre-determined pH value of the silicate aqueous solution is larger then about 7.

Then, in step 108, the organic template precursor solution is poured into the silicate aqueous solution to precipitate out an intermediate, wherein the intermediate includes the surfactant, the carbon source material and a silicon oxide template.

Specifically, in step 108, the organic template precursor solution is quickly poured into the silicate aqueous solution. At this point, a mixed solution of the organic template precursor solution and the silicate aqueous solution immediately precipitates out a white intermediate, which is formed by a silicon oxide condensation reaction to shape the organic template precursor solution. Then, the white intermediate is washed by water, filtered, and baked to form the intermediate with the surfactant, the carbon source material, and the silicon oxide template.

Then, in step 110, a heating process is performed on the intermediate to carbonize the intermediate. Specifically, in step 110, the intermediate may be disposed into a quartz tube which may be disposed into a high-temperature furnace to heat the intermediate in a nitrogen atmosphere at a carbonized temperature for hours to carbonize the intermediate. In one embodiment, the heating process is, for example, performed on the intermediate at 750° C. -850° C. (e.g. 800° C.) for 1 hour to 3 hours (e.g. 2 hours).

Then, in step 112, the silicon oxide template is removed to form a porous carbon material. Specifically, in step 112, the carbonized intermediate is disposed in a strong acid solution (e.g. hydmfluoric acid solution) or a strong base solution to remove the silicon oxide template by using the hydrofluoric acid solution. Specifically, a concentration of the hydrofluoric acid solution is, for example, 4.8 wt %, and a weight ratio of the silicon oxide template to the hydrofluoric acid solution is 1:50.

The present disclosure uses properties of polymer blends to mix the surfactant and the carbon source material so as to form an organic template precursor solution with polymeric micelles. Then, the organic template precursor solution is shaped by a silicon oxide condensation reaction to form a meso-scale material. Then, the meso-scale material is carbonized in a nitrogen atmosphere. Then, the silicon oxide is removed from the carbonized meso-scale material by a hydrofluoric acid solution to form a porous carbon material. Furthermore, process parameters of the porous carbon material may be adjusted depending on particular requirements so as to form a porous carbon material with a well-ordered structure and a large surface area, and a production cost of the porous carbon material is low, which benefits mass production.

Additionally, compared to the conventional manufacturing method of a carbon electrode material, requiring a long process time (about 3-7 days) and more energy (the processing temperature is 2000° C.), the manufacturing method of the present disclosure may effectively shorten process time of the porous carbon material (e.g. in one day) and may lower required energy (the processing temperature ranges from 750° C. to 850° C.).

The structure of the porous carbon material formed by the manufacturing method described above is described as follows in detail.

The porous carbon material of the present disclosure includes a porous carbon structure having a plurality of macropores, a plurality of mesopores and a plurality of micropores, wherein each of the macropores has a diameter larger than 50 nanometers, each of the mesopores has a diameter ranging from 2 nanometers to 50 nanometers, and each of the micropores has a diameter less than 2 nanometers. A specific surface area of the porous carbon structure may range from about 700 square meters per gram to 3000 square meters per gram. A distribution proportion of the specific surface area of the macropores may range from 10-35%, a distribution proportion of the specific surface area of the mesopores may range from 25-40%, and a distribution proportion of the specific surface area of the micropores may range from 30-60%, based on the total specific surface area of the porous carbon structure.

In one embodiment, the specific surface area of the porous carbon structure may range from about 1200 square meters per gram to 2500 square meters per gram. A distribution proportion of the specific surface area of the macropores ranges, for example, from 15-29%, a distribution proportion of the specific surface area of the mesopores ranges, for example, from 30-36%, and a distribution proportion of the specific surface area of the micropores ranges, for example, from 37-54%, based on the total specific surface area of the porous carbon structure.

In general, when the porous carbon material is used as a carbon electrode, of a super capacitor, pore sizes of the porous carbon material may affect a specific capacitance of a charge storage of the super capacitor. Specifically, increasing a number of the micropores may effectively increase a specific surface area of the carbon electrode, and therefore effectively increase the specific capacitance. Furthermore, the mesopores and the macropores may help charges of an electrolyte used in the super capacitor to be transmitted immediately.

The porous carbon materials formed by conventional technology may be roughly categorized into two types. One type of porous carbon material is a micropores carbon material with large numbers of micropores (a distribution proportion of the specific surface area of the micropores is larger than 85%, based on the total specific surface area of the micropores carbon material). Another type of porous carbon material is a macropores carbon material with large numbers of macropores. However, if the distribution proportion of the specific surface area of the micropores of the porous carbon material is too high, the porous carbon material lacks the mesopores and the macropores, and therefore the electrolyte is hardly transmitted into the interior of the porous carbon material, so that merely the outer surface of the porous carbon material is suitable to store charges, which decreases the specific capacitance of the super capacitor. Meanwhile, if the distribution proportion of the specific surface area of the macropores of the porous carbon material is too high, the total specific surface area of the porous carbon material is small, which decreases the specific capacitance of the super capacitor.

It can be known from the above that the present disclosure forms a porous carbon material with micropores, mesopores, and macropores, and therefore when the porous carbon material is used as the carbon electrode of the super capacitor, the micropores may effectively increase the surface area of the carbon electrode (700˜3000 m²/g), and the mesopores and the macropores may serve as charge-transmitting channels (the distribution proportion of the specific surface area of the macropores ranges from 10-35%, and the distribution proportion of the specific surface area of the mesopores ranges from 25-40%), such that the charges of the electrolyte may be smoothly transmitted to the surface of the micropores located in the outer surface and the interior of the carbon electrode through the mesopores and the macropores. As such, a workable thickness of the carbon electrode may be increased, and the surface area of the micropores of the carbon electrode may be utilized fully, which helps to increase ? and quickly transmit the charges of the electrolyte.

The manufacturing method of the porous carbon material according to working examples of the present disclosure will be illustrated as follows. In the working examples below, the surfactant is EO-PO triblock copolymer (Pluronic F127), and the carbon source material is phenolic resin, and the silicate aqueous solution is sodium silicate aqueous solution. The working examples below have roughly similar experimental processes and merely a portion of the experimental parameters are different, so the Example 1. is described in detail, and the second to sixth examples are merely described with the experimental parameters which are different from the Example 1.

### EXAMPLE 1

Firstly, 2 grams of the EO-PO triblock copolymer (surfactant) was dissolved in a solvent formed by water and ethanol (the volume ratio of water to ethanol was 0.5 and a total weight of water and ethanol was 50 grams), and then the solvent was stirred for couple minutes. At this point, the solvent dissolved with the surfactant was a clarified liquid.

Then, 0.5-4 grams of the phenolic resin (carbon source material) was dissolved in the solvent to form an organic template precursor solution. At this point, the solvent was disposed in a constant temperature bath, such that the carbon source material and the solvent achieved balance at a pre-determined temperature (30° C.), and then the solvent was stirred for 4 hours at the pre-determined temperature to form the organic template precursor solution.

Furthermore, 8 grams of the sodium silicate (silicate) was disposed into 150 grams of water, and then the water was stirred for dissolution of the sodium silicate to form the silicate aqueous solution. Then, a pH value of the silicate aqueous solution was adjusted to a pre-determined pH value (pH value=4), and the silicate aqueous solution was disposed in a constant temperature bath to achieve a pre-determined temperature (40° C.) and was maintained for an aging time (7-8 minutes).

Then, the organic template precursor solution was quickly poured into the silicate aqueous solution. Following, a white intermediate was immediately precipitated from the mixed solution of the organic template precursor solution and the silicate aqueous solution. Then, the white intermediate was washed by water, filtered, and baked to form the intermediate with the surfactant, the carbon source material, and the silicon oxide template.

Then, the intermediate was disposed into a quartz tube which was disposed into a high-temperature furnace to heat the intermediate in a nitrogen atmosphere at a carbonized temperature (800° C.) for 2 hours to carbonize the intermediate.

Then, the carbonized intermediate was disposed in a hydrofluoric acid solution (the concentration thereof was 4.8 wt %) to remove the silicon oxide template by using the hydrofluoric acid solution. A weight ratio of the silicon oxide template to the hydrofluoric acid solution was 1:50.

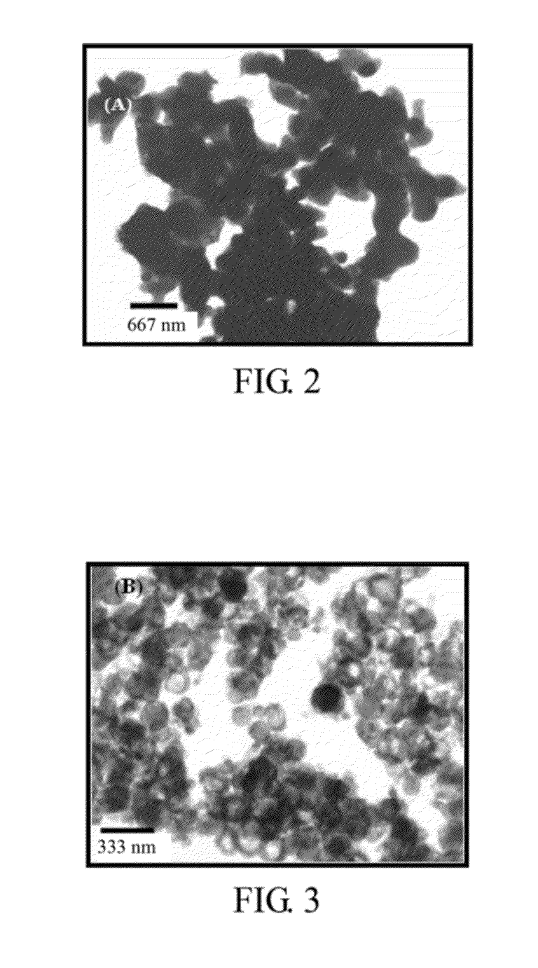

FIG. 2 is a transmission electron microscope (TEM) image of the porous carbon material of the Example 1.

### EXAMPLE 2

The same procedure as in Example 1 was repeated except that the experimental parameters were adjusted as follows:
1. a pre-determined pH value of the silicate aqueous solution was about 4;
2. a pre-determined temperature of the carbon source material, the solvent and the silicate aqueous solution was 40° C.;
3. the solvent included water and ethanol, wherein the volume ratio of water to ethanol was 1.

FIG. 3 is a TEM image of the porous carbon material of the Example 2.

### EXAMPLE 3

The same procedure as in Example I was repeated except that the experimental parameters were adjusted as follows:
1. a pre-determined pH value of the silicate aqueous solution was about 4;
2. a pre-determined temperature of the carbon source material, the solvent and the silicate aqueous solution was 40° C.;
3. the solvent included water and ethanol, wherein the volume ratio of water to ethanol was 5.

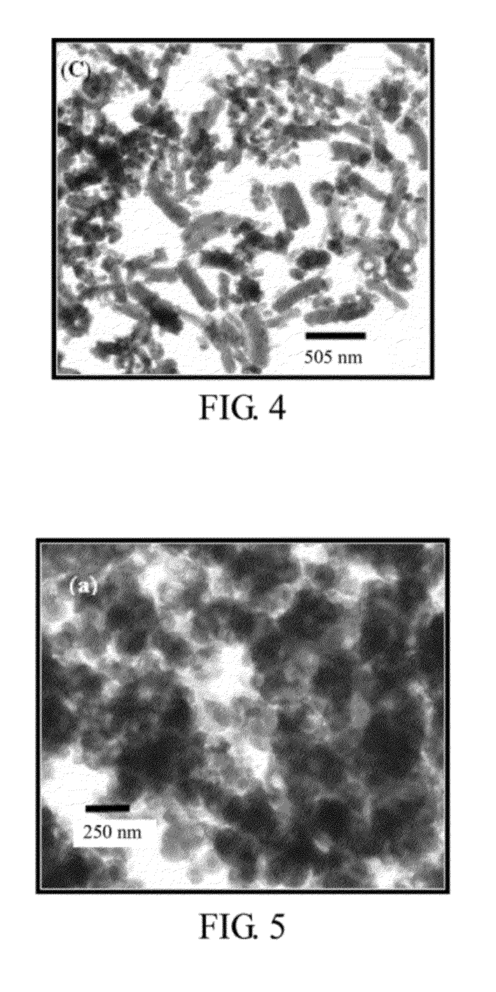

FIG. 4 is a TEM image of the porous carbon material of the Example 3.

Referring to FIGS. 2-4, it can be known from FIGS. 2-4 that the resulting porous carbon material had a more well-ordered spherical structure (as shown in FIGS. 2-3) as the volume ratio of the ethanol in the solvent increased. When the volume ratio of the water in the solvent was too high, such as in Example 3, the morphology of the resulting porous carbon material changed. If the concentration of the ethanol decreased, the resulting porous carbon material had more short rod structures (as shown in FIG. 4). It was observed that the short stick structure was formed by a plurality of spherical structures connected with each other.

### EXAMPLE 4

The same procedure as in Example 1 was repeated except that the experimental parameters were adjusted as follows:
1. a pre-determined pH value of the silicate aqueous solution was about 4;
2. a pre-determined temperature of the carbon source material, the solvent and the silicate aqueous solution was 30° C.;
3. the solvent included water and ethanol, wherein the volume ratio of water to ethanol was 1.

FIG. 5 is a TEM image of the porous carbon material of the Example 4.

### EXAMPLE 5

The same procedure as in Example 1 was repeated except that the experimental parameters were adjusted as follows:
1. a pre-determined pH value of the silicate aqueous solution was about 4;
2. a pre-determined temperature of the carbon source material, the solvent and the silicate aqueous solution was 30° C.;
3. the solvent included water and ethanol, wherein the volume ratio of water to ethanol was 2.

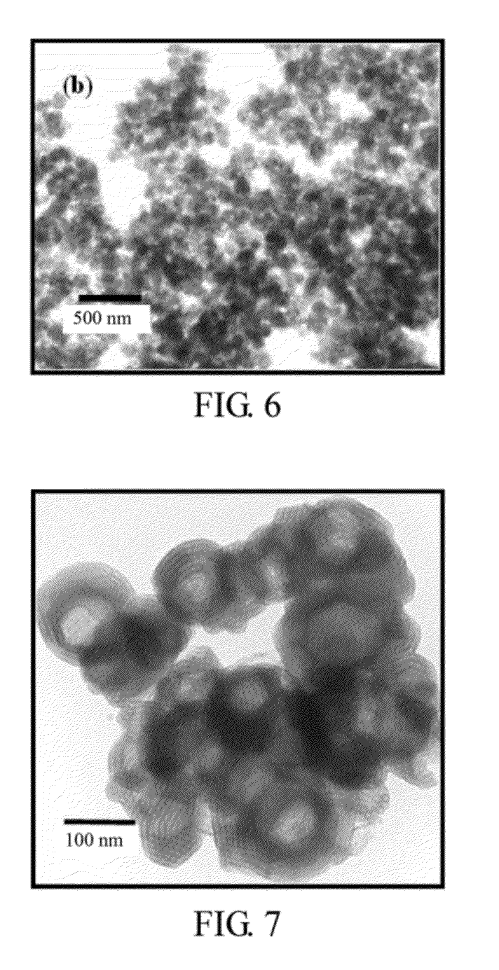

FIG. 6 is a TEM image of the porous carbon material of the Example 5.

### EXAMPLE 6

The same procedure as in Example 1 was repeated except that the experimental parameters were adjusted as follows:
1. a pre-determined pH value of the silicate aqueous solution was about 10;
2. a pre-determined temperature of the carbon source material, the solvent and the silicate aqueous solution was 30° C.;
3. the solvent was water.

Specifically, in Example 6, the solvent was water, and the organic template precursor solution was acidic (the pH value thereof was about 3-6, and the best mode was 4) to disperse the carbon source material. The silicate aqueous solution was basic? (the pH value was 10). The acidic organic template precursor solution may be poured into the basic silicate aqueous solution to form a mixed solution. If so, the pH value would change during mixing the acidic organic template precursor solution and the basic silicate aqueous solution, and the pH value of the mixed solution would be adjusted to about 10.

FIG. 7 is a TEM image of the porous carbon material of the Example 6. It can be known from FIG. 7 that the structure of the porous carbon material of Example 6 was spherical and has well-ordered pores. The manufacturing method of Example 6 may not need to use ethanol.

Also, after comparing FIGS. 2-7, it can be known that when the pre-determined temperature of the carbon source material, the solvent, and the silicate aqueous solution rose (as shown in FIGS. 2-4 respectively corresponding to the Example 1, the Example 2 and the Example 3), the pore wall structure was better ordered. Therefore, the pore wall structure may be changed by adjusting the pre-determined temperature,

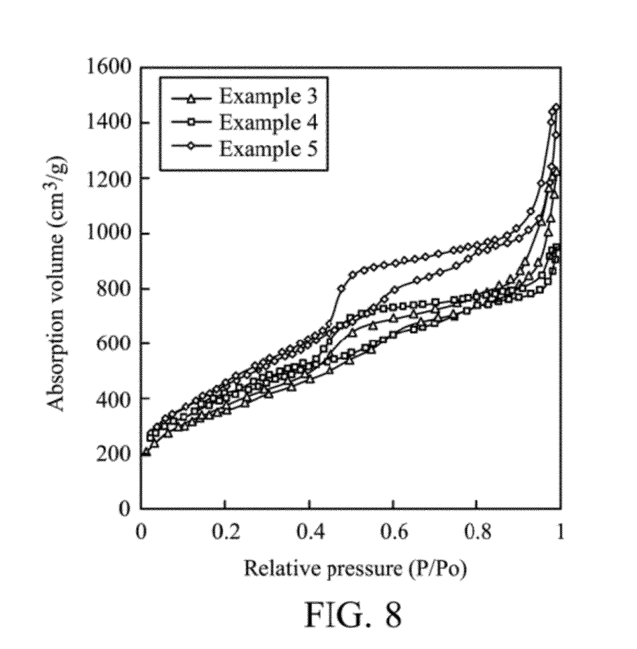

FIG. 8 is a curve diagram showing that nitrogen adsorption/desorption curves of the porous carbon materials of the Example 3, the Example 4, and the Example 5. It can be known from FIG. 8 that the porous carbon material had an adsorption amount in low relative pressure (P/P₀=0.3), and the adsorption amount resulted from a monolayer adsorption of nitrogen on the pore walls of the micropores of the porous carbon material. The nitrogen adsorption amount was increasing as the P/P₀ was increasing. In P/P₀=0.40, a capillary condensation phenomenon occurred, which resulted in a steep rise in the nitrogen adsorption amount. At this point, the nitrogen had substantially filled the micropores.

The uniformity of the pore sizes of a sample may be determined by the degree of steepness of the capillary condensation phenomenon. The steeper the capillary condensation phenomenon is, the more uniform the pore sizes are. It can be known from FIG. 8 that the porous carbon materials of the Example 3, the Example 4, and the Example 5 rose steeply in the nitrogen adsorption amounts in P/P₀=0.40, so the porous carbon materials of the Example 3, the Example 4, and the Example 5 had uniform pore sizes. When the relative pressure (P/P₀) ranged from 0.4 to 0.95, nitrogen filled the mesopores gradually. When the relative pressure (P/P₀) was 0.95, the nitrogen adsorption amount rose obviously, which represented that the resulting porous carbon material had larger pores.

The Table 1 below lists the nitrogen adsorption/desorption measurement results of the porous carbon materials of the Example 3, the Example 4, the Example 5, and a commercial product, wherein the commercial porous carbon material was bought from Yeong Long Technologies CO., LTD. The nitrogen adsorption/desorption measurement results include the specific surface area, and the distribution proportions of the specific surface areas of the macropores, the mesopores, and the micropores, based on the total specific surface area of the porous carbon material.

TABLE 1

| | Specific | | | |
|---|---|---|---|---|
| | surface | | | |
| | area | Macropores | Mesopores | Micropores |
| | (m²/g) | (%) | (%) | (%) |
| Example 3 | 1284.00 | 27.1 | 34.2 | 38.7 |
| Example 4 | 1354.82 | 15.9 | 31.1 | 53.0 |
| Example 5 | 1550.35 | 27.2 | 31.9 | 40.9 |
| Commercial porous | 1043.62 | 3.9 | 8.0 | 88.1 |
| carbon material | | | | |

It can known from Table 1 that, compared with the commercial porous carbon material, the porous carbon materials of the Example 3, the Example 4, and the Example 5 had larger specific surface areas and uniform proportions of macropores, mesopores, and micropores. Thus, the micropores may effectively increase the surface area of the carbon electrode, and the mesopores and the macropores may be charge-transmitting channels, which helps to increase the amount of storage charges and quickly transmit the charges of the electrolyte.

In view of the foregoing, the manufacturing method of the present disclosure uses properties of polymer blends to mix the surfactant and the carbon source material so as to form an organic template precursor solution. Then, the organic template precursor solution is shaped by a silicon oxide condensation reaction to form a meso-scale material. Then, the meso-scale material is carbonized, and then the silicon oxide is removed from the carbonized meso-scale material to form a porous carbon material. The manufacturing method of the present disclosure has advantages of a low production cost, short process time and lower required energy, which benefits mass production. Additionally, the porous carbon material of the present disclosure has micropores, mesopores, and macropores. Thus, when the porous carbon material is applied in carbon electrodes of super capacitors, the micropores may effectively increase the surface area of the carbon electrode, and the mesopores and the macropores may be charge-transmitting channels, which helps to increase the amount of storage charges and quickly transmit the charges of the electrolyte.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A manufacturing method of a porous carbon material, comprising dissolving a surfactant and a carbon source material in a solvent to form an organic template precursor solution;
preparing a silicate aqueous solution;
pouring the organic template precursor solution into the silicate aqueous solution to precipitate out an intermediate, wherein the intermediate includes the surfactant, the carbon source material and a silicon oxide template;
heating the intermediate to carbonize the intermediate; and
removing the silicon oxide template to form a porous carbon material.

2. The manufacturing method of a porous carbon material as claimed in claim 1, wherein the solvent comprises water, alcohols, or combinations thereof.

3. The manufacturing method of a porous carbon material as claimed in claim 2, wherein the solvent is ethanol or a combination of water and ethanol.

4. The manufacturing method of a porous carbon material as claimed in claim 1, wherein the silicate aqueous solution has a pH ranging from 2 to 7.

5. The manufacturing method of a porous carbon material as claimed in claim 1, wherein the silicate aqueous solution has a pH less than about 2.

6. The manufacturing method of a porous carbon material as claimed in claim 1, wherein the silicate aqueous solution has a pH larger than about 7.

7. The manufacturing method of a porous carbon material as claimed in claim 1, wherein the solvent is water, the organic template precursor solution is acidic, the silicate aqueous solution is basic, and the step of pouring the organic template precursor solution into the silicate aqueous solution to precipitate out the intermediate comprises:
pouring the acidic organic template precursor solution into the basic silicate aqueous solution to form a mixed solution; and
adjusting the pH of the mixed solution to about 10.

8. The manufacturing method of a porous carbon material as claimed in claim 1, wherein the step of preparing the silicate aqueous solution comprises:
dissolving a silicate in water to form the silicate aqueous solution;
adjusting a pH of the silicate aqueous solution to a pre-determined pH; and
adjusting a temperature of the silicate aqueous solution to a pre-determined temperature which ranges from 1° C. to 99° C.

9. The manufacturing method of a porous carbon material as claimed in claim 1, wherein the surfactant comprises gelatin, EO-PO triblock copolymer, poly ethylene glycol, or combinations thereof.

10. The manufacturing method of a porous carbon material as claimed in claim 1, wherein the carbon source material comprises phenolic resins, crosslinked and non-crosslinked polyacrylonitrile copolymers, sulfonated crosslinked polystyrene copolymers, modified crosslinked polystyrene copolymers, crosslinked sucrose, poly(furfuryl alcohol), polyvinyl chloride, or combinations thereof.

11. The manufacturing method of a porous carbon material as claimed in claim 1, wherein the heating comprises heating the intermediate at 750° C.-850° C. for 1 hour-3 hours.

12. The manufacturing method of a porous carbon material as claimed in claim 1, wherein the step of removing the silicon oxide template comprises:
removing the silicon oxide template by using a strong acid solution or a strong base solution.

13. A porous carbon material, comprising
a porous carbon structure having a plurality of macropores, a plurality of mesopores and a plurality of micropores, wherein each of the macropores has a diameter larger than 50 nanometers, each of the mesopores has a diameter ranging from 2 nanometers to 50 nanometers, and each of the micropores has a diameter less than 2 nanometers, and a specific surface area of the porous carbon structure ranges from about 700 square meters per gram to 3000 square meters per gram,
wherein a distribution proportion of the specific surface area of the macropores ranges from 10-35%, a distribution proportion of the specific surface area of the mesopores ranges from 25-40%, and a distribution proportion of the specific surface area of the micropores ranges from 30-60%, based on the total specific surface area of the porous carbon structure.

14. The porous carbon material as claimed in claim 13, wherein the specific surface area of the porous carbon structure ranges from about 1200 square meters per gram to 2500 square meters per gram.

15. The porous carbon material as claimed in claim 14, wherein a distribution proportion of the specific surface area of the macropores ranges from 15-29%, a distribution proportion of the specific surface area of the mesopores ranges from 30-36%, and a distribution proportion of the specific surface area of the micropores ranges from 37-54%, based on the total specific surface area of the porous carbon structure.
